(19) United States
(12) Patent Application Publication
(10) Pub. No.: US 2006/0041884 A1
(43) Pub. Date: Feb. 23, 2006

(54) Function enhancing program, bundled software function enhancing method and apparatus

(75) Inventor: Yumiko Nakamura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/995,267

(22) Filed: Nov. 24, 2004

(30) Foreign Application Priority Data
Aug. 20, 2004 (JP) 2004-240427

(51) Int. Cl. G06F 9/445

(52) U.S. Cl. 717/176; 717/171

(57) ABSTRACT

A formal purchase request of the bundled software is transmitted to a server retained by a software manufacturer and a confirmation response to the formal purchase is received, and a provision confirmation request of the bundled software is transmitted to a server retained by an apparatus manufacturer and a provision confirmation response is received, and an expansion function of the bundled software is made available when both of the confirmation response to the formal purchase from the server retained by the software manufacturer and the provision confirmation response from the server retained by the apparatus manufacturer have been received.

This application is a priority based on prior application No. JP 2004-240427, filed Aug. 20, 2004, in Japan.

### BACKGROUND OF THE INVENTION

1. Field of the Invention

The present invention relates generally to a function enhancing program, method and apparatus that enhance functions of software bundled to a personal computer, and more particularly, to a function enhancing program, method and apparatus that make extended functions provided by the manufacturer of the personal computer, available using bundled software.

2. Description of the Related Art

Conventionally, manufacturers of personal computers bundle a large number of pieces of software in cooperation with software manufacturers and prepare users who have purchased personal computers to be able to utilize the personal computers from the time of the purchase without purchasing any software package individually. In general, compared to software called “package version” sold individually, the bundled software has various restrictions such as that the bundled software is simplified by omitting a part of the functions thereof, that the term for use is limited, etc., (see, e.g., Japanese Patent Application Nos. 2003-015987, 2001-035092, 1999-149413, 2000-172361 and 2000-099403).

However, the conventional software bundled with a personal computer has almost no difference between manufacturers and between models of personal computers and, therefore, the original role of the bundled software that intends to draw out the desire of users for purchase by facilitating differentiation from competitors' products is getting unimportant. On the other hand, in recent years, enhancement of security functions is important even for personal computers. However, simple security functions provided by package software can not take sufficient measures and enhancement of the security functions under secure software and hardware environments provided by the manufacturers of personal computers is demanded.

### SUMMARY OF THE INVENTION

According to the present invention there are provided a recording medium which stores a function enhancement program, method and apparatus that are adapted to facilitate differentiation of bundled software by making expansion functions provided by apparatus manufacturers available for bundled software supplied by software manufacturers.

(Recording Medium)

The present invention provides a recording medium which stores a bundled software function enhancing program run by a computer. The function enhancing program of the present invention is operable to drive the computer to execute:
a bundled software purchase processing step of transmitting a formal purchase request of the bundled software to a server of a software manufacturer and receiving a confirmation response to the formal purchase;
a bundled software provision confirmation step of transmitting a provision confirmation request of the bundled software to a server of an apparatus manufacturer and receiving a provision confirmation response; and
an expansion function utilization processing step of making the expansion function of the bundled software available when receiving both of the confirmation response to the formal purchase from the server of the software manufacturer and the provision confirmation response from the server of the apparatus manufacturer.

The bundled software provision confirmation step includes transmitting an apparatus model number to the server of the apparatus manufacturer as the provision confirmation request of the bundled software and receiving the provision confirmation response. The expansion function utilization processing step includes confirming utilization data and making the expansion function available when receiving both of the confirmation response to the formal purchase from the server of the software manufacturer and the provision confirmation response from the server of the apparatus manufacturer. The expansion function utilization processing step may include making an expansion function installed in advance available when receiving both of the confirmation response to the formal purchase from the server of the software manufacturer and the provision confirmation response from the server of the apparatus manufacturer. The expansion function utilization processing step may include making available an expansion function downloaded with the confirmation response to the formal purchase from the server of the software manufacturer when receiving both of the confirmation response to the formal purchase from the server of the software manufacturer and the provision confirmation response from the server of the apparatus manufacturer. The expansion function utilization processing step includes executing a file storage processing provided with a security function. The expansion function utilization processing step includes encrypting and storing a file provided by the bundled software in a storage area of the apparatus that is accessible from the expansion menu. The expansion function utilization processing step includes encrypting and storing a file provided by the bundled software in a storage area of the apparatus that is accessible from the expansion menu provided that a permission response is obtained to an authentication request to the server of the apparatus manufacturer using a serial number specific to the apparatus. The expansion function utilization processing step includes encrypting and storing a file provided by the bundled software in a storage area of the server of the apparatus manufacturer that is accessible from the expansion menu. The expansion function utilization processing step includes encrypting and storing a file provided by the bundled software in a storage area of the server of the apparatus manufacturer that is accessible from the expansion menu provided that a permission response is obtained to an authentication request to the server of the apparatus manufacturer using a serial number specific to the apparatus.

(Method)

The present invention provides a bundled software function enhancing method for expanding the function of bundled software bundled, the method comprising:
a bundled software purchase processing step of transmitting a formal purchase request of the bundled software to a server of a software manufacturer and receiving a confirmation response to the formal purchase;
a bundled software provision confirmation step of transmitting a provision confirmation request of the bundled software to a sever of an apparatus manufacturer and receiving a provision confirmation response; and
an expansion function utilization processing step of making the expansion function of the bundled software available when receiving both of the confirmation response to the formal purchase from the server of the software manufacturer and the provision confirmation response from the server of the apparatus manufacturer.

(Apparatus)

The present invention provides an information processing unit such as a personal computer. The information processing apparatus of the present invention comprises a bundled software purchase processing unit transmitting a formal purchase request of the bundled software to a server of a software manufacturer to receive a confirmation response to the formal purchase; a bundled software provision confirmation unit transmitting a provision confirmation request of the bundled software to a sever of an apparatus manufacturer to receive a provision confirmation response; and an expansion function utilization processing unit making the expansion function of the bundled software available when receiving both of the confirmation response to the formal purchase from the server of the software manufacturer and the provision confirmation response from the server of the apparatus manufacturer.

(Management Apparatus)

The present invention provides a management apparatus having a bundled software database. The management apparatus of the present invention comprises:
a communication control unit communicating with at least one computer;
a bundled data storage unit storing in a correlated manner an apparatus model number of the at least one computer, an identifier of the bundled software loaded in the at least one computer and an expansion function provided by the management apparatus; and
an expansion service processing unit executing the expansion function of the bundled software based on the identifier of the at least one computer.

Details of the bundled software function enhancing method and the information processing apparatus in accordance with the present invention will become essentially the same as those of the function enhancing program of the present invention. According to the present invention, a user can utilize a specific menu prepared as an expansion function provided by the manufacturer, at the time when the user is registered as a formal user through the formal purchase of the bundled software of a personal computer and the bundled software is confirmed to be the bundled software provided by the apparatus manufacturer. Moreover, utilization of the expansion functions of the bundled software of the present invention is effective only for models of manufacturers to which the present invention is applied and products that are considerably differentiated from models of other manufacturers to which only bundled software having no expansion function of the present invention is bundled can be provided. By causing a security file management function that is a problem in many aspects today to be available as an expansion function of the bundled software provided by the present invention, a mechanism that stores data and files into an area where a user can not access directly to is made available and even bundled software can prevent securely unauthorized deleting and thefts of data using the function enhancement. Furthermore, because a user is required to formally purchase bundled software in order to utilize the expansion functions, a software manufacturer providing the bundled software can obtain promotion of sales and profit by the formal purchase of the user though the expansion function is provided by the apparatus manufacturer. Moreover, the load to enhance the functions can be made small because the expansion functions of the bundled software are provided by the apparatus manufacture and the software manufacturer only provide an interface with expansion functions such as, for example, an expansion menu. The above and other objects, features and advantages of the present invention will become more apparent from the following detailed description with reference to the drawings.

### BRIEF DESCRIPTION OF THE DRAWINGS

FIGS. 1A and 1B are illustrative views showing the configuration of a bundled software enhancement function of the present invention together with the system environment;

FIG. 2 is an illustrative view of a bundled software database provided to a server retained by an apparatus manufacturer;

FIGS. 3A and 3B are illustrative views of a screen of an expansion menu of the bundled software used in a user information processing apparatus of FIG. 2;

FIG. 4 is a block diagram of the hardware environment of a computer that is the user information processing apparatus of FIGS. 1A and 1B;

FIGS. 5A and 5B are flowcharts of a function expansion process by the user information processing apparatus of FIG. 2;

FIG. 6 is a flowchart of a security file management process of storing in the user information processing apparatus as an example of an expansion function according to the present invention;

FIGS. 7A and 7B are flowcharts of a security file management process of storing in the user information processing apparatus based on an authentication process as an example of an expansion function according to the present invention;

FIG. 8 is a flowchart of a security file management process of storing in the server of the apparatus manufacturer as an example of an expansion function according to the present invention; and

FIGS. 9A and 9B are flowcharts of a security file management process of storing in the server of the apparatus manufacturer based on an authentication process as an example of an expansion function according to the present invention.

### DETAILED DESCRIPTION OF THE PREFERRED EMBODIMENT

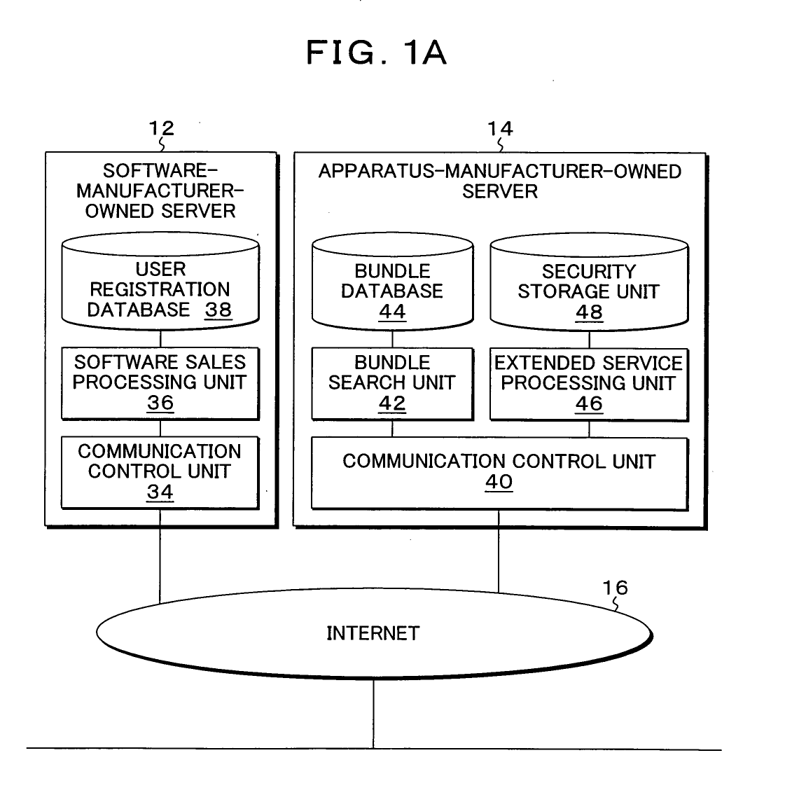

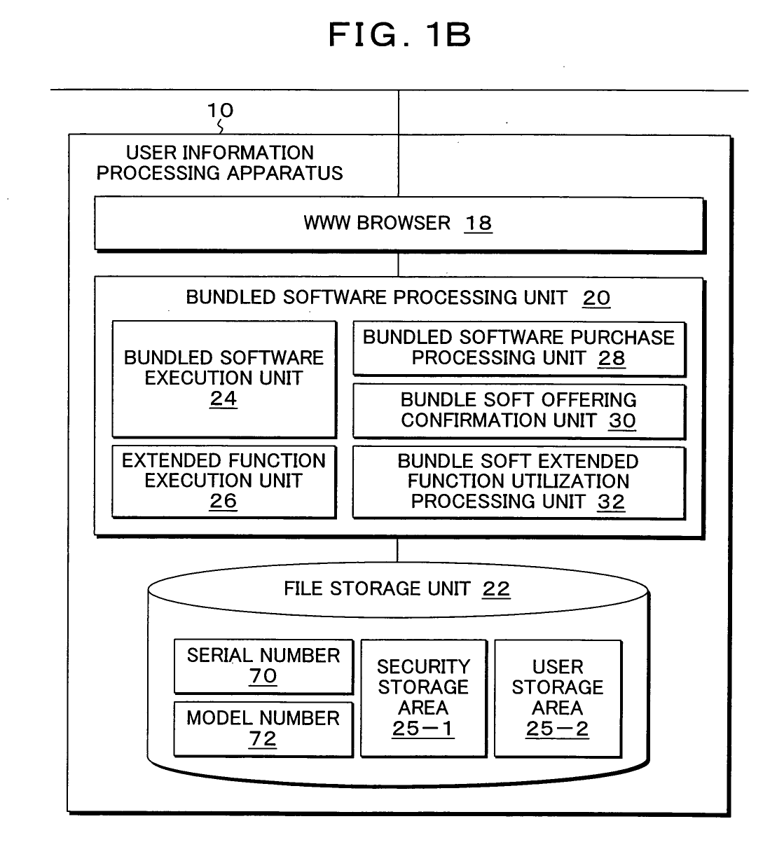

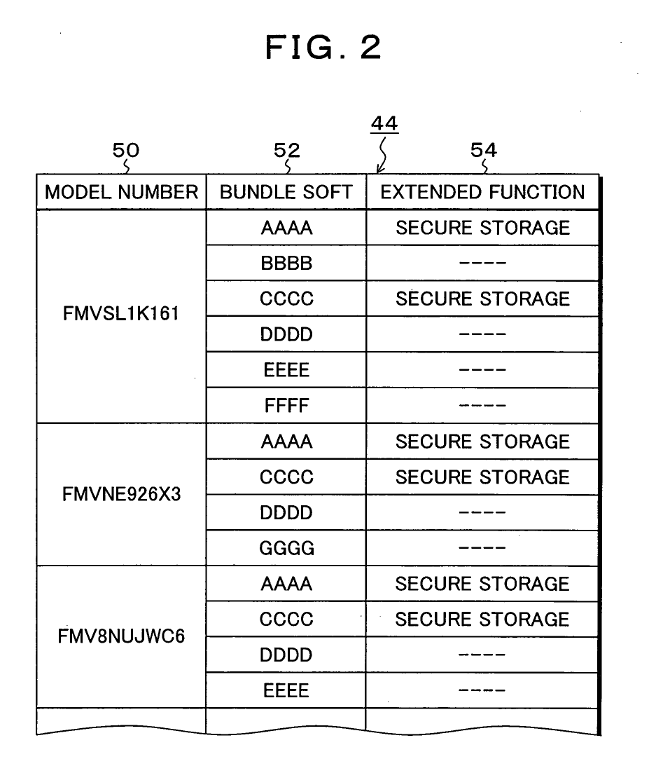

FIGS. 1A and 1B are illustrative views of an embodiment showing the functional configuration of a function enhancement process of bundled software according to the present invention together with a system environment. In FIGS. 1A and 1B, a user information processing apparatus 10 is a personal computer, etc. installed with a function enhancing program of bundle software according to the present invention and is adapted to be able to be connected through the Internet 16 with a server 12 retained by a software manufacturer that is the software manufacturer providing the bundled software and a server 14 retained by an apparatus manufacturer that is the apparatus manufacturer of the user information terminal apparatus 10. The user information processing apparatus 10 is provided with a WWW browser 18, a bundled software processing unit 20 and a file storage unit 22. The bundled processing unit 20 is more specifically an OS of a personal computer and is provided with a bundled software executing unit 24, an expansion function executing unit 26, a bundled software purchase processing unit 28, a bundled software provision confirming unit 30 and a bundled software expansion function utilization processing unit 32 as functions realized by executing a program. The file storage unit 22 is, for example, a hard disk drive (HDD) provided to a personal computer and, in this embodiment, a security storage area 25-1 is provided in addition to a user storage area 25-2 because a security file storage is taken as an example as an expansion function of the bundled software. The security storage area 25-1 is secured in, for example, a system area that the user can not access to. In the file storage unit 22, a serial number 70 and a model number 72 that the apparatus manufacturer has given to the user information processing apparatus 10 during the manufacture thereof are stored. On the other hand, the server 12 retained by the software manufacturer that is operated and managed by the software manufacturer that provides the bundled software in cooperation with the manufacturer of the user information processing apparatus 10, is provided with a communication control unit 34, a software sales processing unit 36 and a user registration database 38. In addition, the server 14 retained by the apparatus manufacturer that is operated and managed by the manufacturer of the user information processing apparatus 10, is provided with a communication control unit 40, a bundled software retrieving unit 42, a bundled software database 44, an expansion service processing unit 46 and a security storage unit 48. The bundled software executing unit 24 provided to the bundled software processing unit 20 of the user information processing apparatus 10 reads and executes a plurality pieces of software bundled in advance when the manufacturer sold the user information processing apparatus 10, so-called “bundled software”. The bundled software executed by the bundled software executing unit 24 includes such various types of software provided by the apparatus manufacturer in cooperation with the software manufacturer as mainly document creating software, for example, Word (a registered trademark), Excel (a registered trademark) and Oasis (a registered trademark), and is stored in the hard disk drive (HDD) constituting the file storage unit 22. The expansion function executing unit 26 executes expansion programs provided from the apparatus manufacturer corresponding to the bundled software bundled with the user information processing apparatus 10. For example, when the bundled software is document creating software, a function for security storage of document files created by this bundled software is provided from the apparatus manufacturer as an expansion function. The expansion function program for realizing the function of the expansion function executing unit 26 may be bundled as a piece of bundled software in advance when the user information processing apparatus 10 is shipped, or may be downloaded from the side of the server 12 retained by the software manufacturer when the extension functions of the bundled software disclosed in the description below is made available. The bundled software purchase processing unit 28 transmits a formal purchase request of the bundled software to the server 12 retained by the software manufacturer and receives a confirmation response to the formal purchase when the user needs to use the expansion function of the bundled software. Having received this formal purchase request from the bundled software purchase processing unit 28, the server 12 retained by the software manufacturer provides, for example, a homepage of the server 12 retained by the software manufacturer for purchase of software to the WWW browser 18 of the user information processing apparatus 10 by the process of the software sales processing unit 36, causes the WWW browser 18 to display the homepage on a screen, inputs information by the operation necessary for the purchase by a user who uses the screen and, when the sales of the software is established, registers the user into the user information database 38 as well as transmits a confirmation response to the formal purchase to the user information processing apparatus 10. The bundled software provision confirming unit 30 of the user information processing apparatus 10 transmits a provision confirmation request of the bundled software to the server 14 retained by the apparatus manufacturer and receives a provision confirmation request response. The provision confirmation request of the bundled software to the server 14 retained by the apparatus manufacturer is executed by transmitting the serial number 70 and the model number 72 of the user information processing apparatus 10. Having received the provision confirmation request of the bundled software from the user information processing apparatus 10, the server 14 retained by the apparatus manufacturer, after confirming in the bundled software retrieving unit 42 that the user information processing apparatus 10 is an apparatus manufactured by the apparatus manufacturer from the received serial number 70, retrieves whether the bundled software is bundled software bundled by the apparatus manufacturer by referring to the bundled software database 44 using the model number 72 and transmits the result of the retrieval to the user information processing apparatus 10 as the provision confirmation response of the bundled software. Here, the bundled software database 44 of the server 14 retained by the apparatus manufacturer stores, for example, data listed in FIG. 2.

In FIG. 2, the bundled database 44 comprises model numbers 50, names of bundled software 52 and expansion functions 54. The model number 50 is an ID number written on the user information processing apparatus 10 during the manufacture thereof and a list of names of bundled software 52 bundled corresponding to this model number 50 is registered. Therefore, the name of the bundled software being bundled can be retrieved by referring to the bundled software database 44 using the model number 50 received from the user information processing apparatus 10. For example, when a provision confirmation request for utilizing an expansion function for bundled software “AAAA” is received from the user information processing apparatus 10, the name of the bundled software 52 is retrieved from the model number 50 and, from the fact that the name of the bundled software can be retrieved, the provision confirmation response representing that the bundled software is software that the apparatus manufacturer has bundled is transmitted to the user information processing apparatus 10.

Referring again to FIGS. 1A and 1B, the bundled software expansion function utilization processing unit 32 provided to the bundled software processing unit 20 turns on a utilization flag when both of the confirmation response to the formal purchase from the server 12 retained by the software manufacturer by the bundled software purchase processing unit 28 and the provision confirmation response from the server 14 retained by the apparatus manufacturer have been received, and the expansion function is made available by the turning on of the utilization flag.

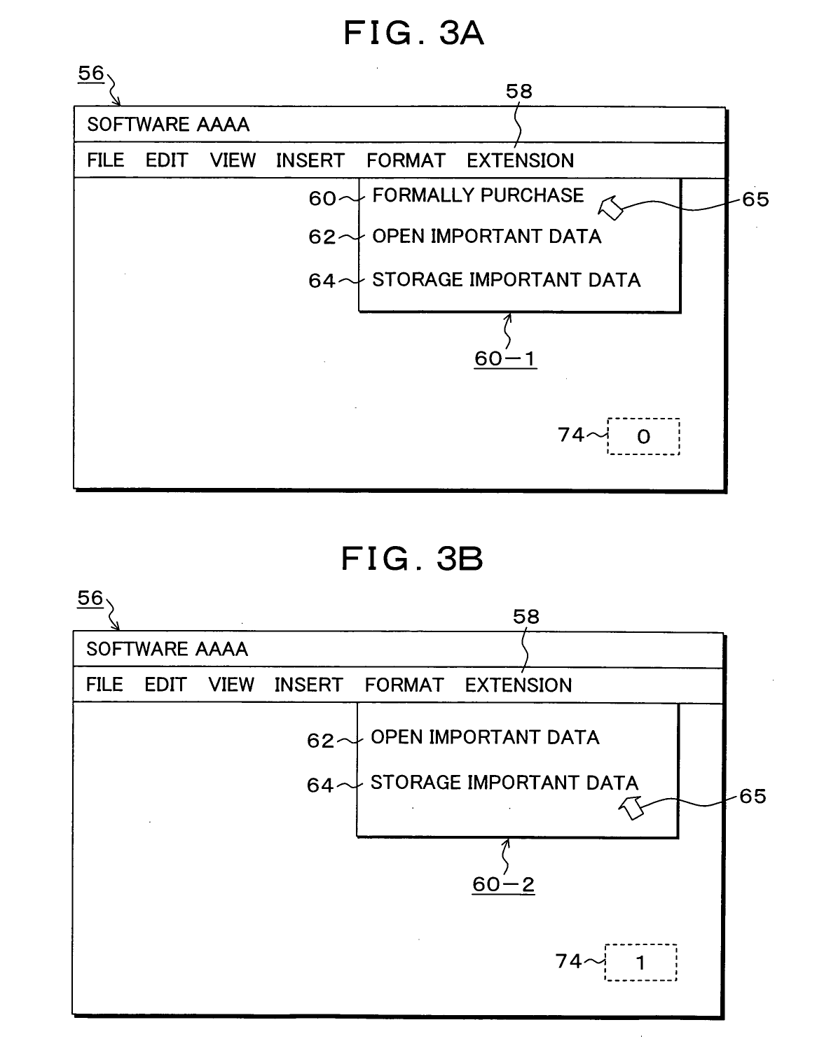

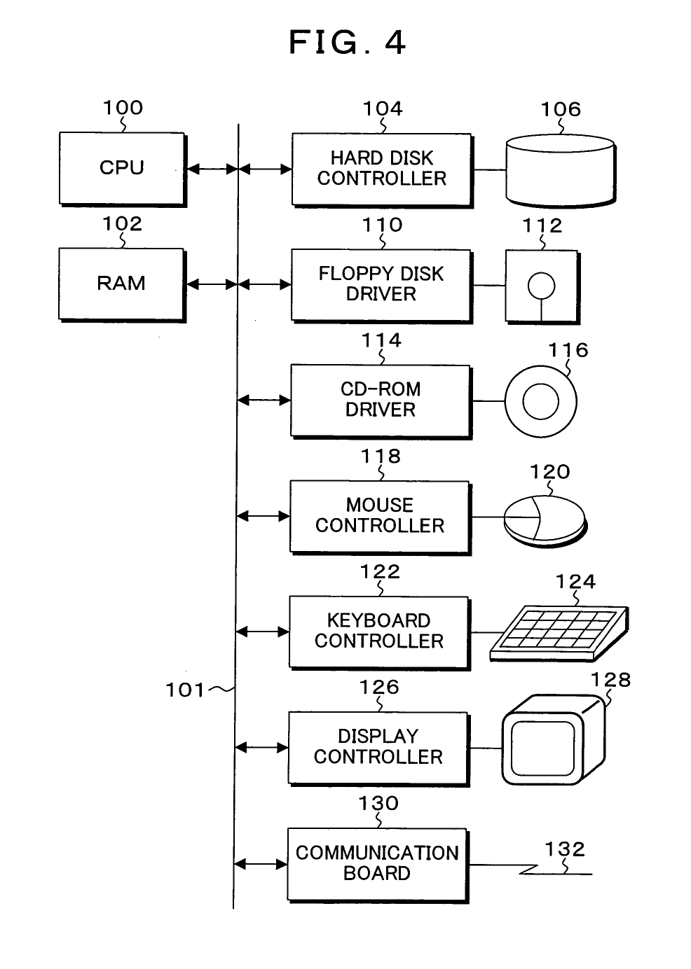

FIGS. 3A and 3B are illustrative views of a screen for utilizing the expansion functions of the bundled software executed by the bundled software processing unit 20 of the user information processing apparatus 10 of FIGS. 1A and 1B. FIG. 3A shows a utilization screen 56 of the software AAAA that is the bundled software, and an expansion menu 60-1 is displayed on the screen when a mouse cursor has been moved to an expansion operating unit 58 among operation items shown on a control bar and “expansion” is clicked. On the expansion menu 60-1, three (3) items of “formally purchase”, “open important data” and “store important data” are displayed respectively as menu selection operating units 60, 62 and 64. A utilization flag 74 displayed virtually on the screen managed by the bundled software expansion function utilizing unit 32 of FIGS. 1A and 1B in the initial state is turned off to be “0 (zero)” and the expansion function can not be utilized. In order to utilize the expansion function of security storage that the software AAAA has in the expansion menu 60-1, first, the portion, “formally purchase” of the menu selection operating unit 60 is clicked with the mouse cursor 65. When this “formally purchase” of the menu selection operating unit 60 has been clicked, the bundled software purchase processing unit 28 and the bundled software provision confirming unit 30 provided to the user information processing apparatus 10 of FIGS. 1A and 1B start operating, execute the formal purchase request to the server 12 retained by the software manufacturer, receive the confirmation response of the request, executes the provision confirmation request to the server 14 retained by the apparatus manufacturer and receive the provision confirmation response of the request. When both of the confirmation response to the formal purchase from the server 12 retained by the software manufacturer and the provision confirmation response from the server 14 retained by the apparatus manufacturer have been received, the utilization flag 74 is turned on to be “1 (one)” as shown virtually in FIG. 3B. Thereby, an expansion menu 60-2 is displayed and the state is realized where the two (2) expansion functions of “open important data” that is security deployment and “store important data” that is security storage by the menu selection operating units 62 and 64 can be effectively utilized. The user information processing apparatus 10 of the present invention of FIGS. 1A and 1B can be realized by, for example, a hardware resource such as a computer as shown in FIG. 4.

In the computer of FIG. 4, a bus 101 of a CPU 100 is connected with an RAM 102, a hard disk controller (software) 104, a floppy disk driver (software) 110, a CD-ROM driver (software) 114, a mouse controller 118, a keyboard controller 122, a display controller 126 and a communication board 130. The hard disk controller (software) 104 is connected with a hard disk drive 106, is loaded with the function enhancing program that makes the expansion function of the bundled software of the present invention available, evokes necessary programs from the hard disk drive 106 when the computer is started up, deploys the program on the RAM 102 and executes the program using the CPU 100. The floppy disk driver 110 is connected with a floppy disk driver (hardware) 112 and can read/write floppy disks (a registered trademark). The CD-ROM driver 114 is connected with a CD drive (hardware) 116 and can read in data and programs stored in CDs. The mouse controller 118 transmits input operations of a mouse 120 to the CPU 100. The key board controller 122 transmits input operations on a keyboard 124 to the CPU 100. The display controller 126 executes display on a display unit 128. The communication board 130 executes communication with the server 12 retained by the software manufacturer and the server 14 retained by the apparatus manufacturer through a network such as the Internet, etc. using communication lines 132 including a wireless line.

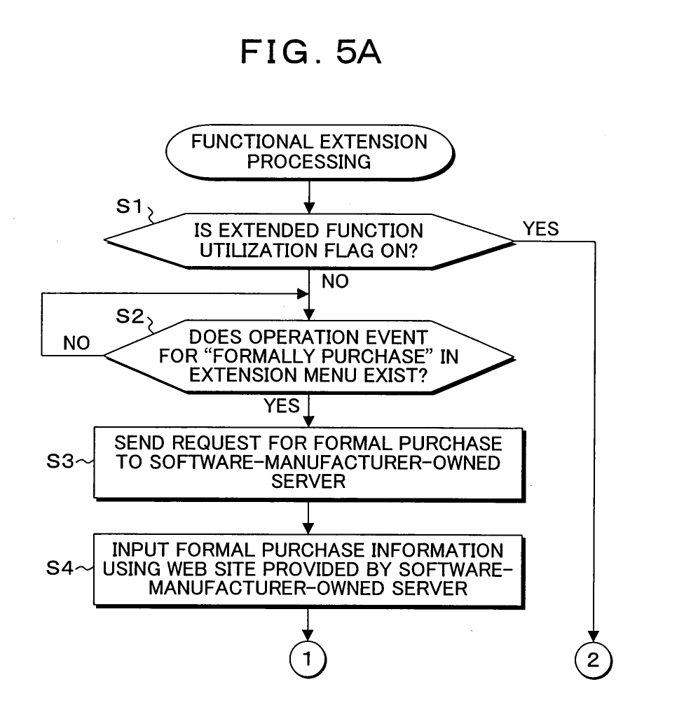

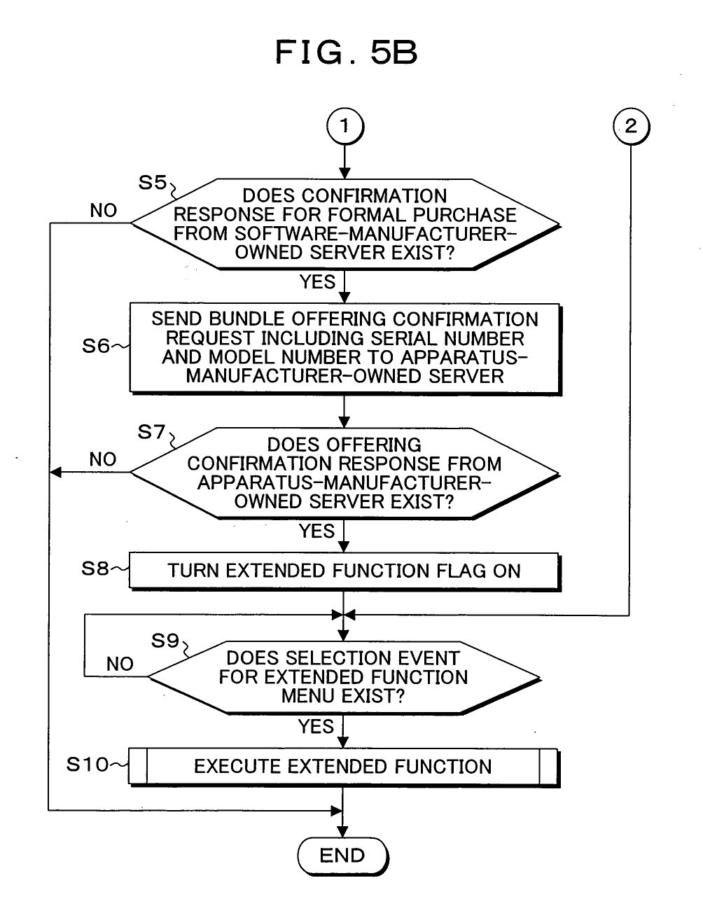

FIGS. 5A and 5B are flowcharts of a function expansion process by the user information apparatus 10 of FIG. 2. In FIGS. 5A and 5B, when the function expansion process is started up, whether or not the utilization flag of the expansion function is turned on is checked at a step S1. If the flag is turned off, the expansion function is in a state where the expansion function is not available. Therefore, the procedure advances to a step S2 and whether or not a selected event in the menu of “formally purchase” in the expansion menu 60-1 of the utilization screen 56 as shown in FIG. 3A is present is checked. If the selected event is present, the procedure advances to a step S3 and a formal purchase request of the bundled software is transmitted to the server 12 retained by the software manufacturer. In response to this transmission of the formal purchase request, a homepage necessary for operation input of the formal purchase can be watched from the side of the server 12 retained by the software manufacturer and information for formal purchase is inputted at a step S4 utilizing this homepage. Then, whether or not a confirmation response to the formal purchase is returned from the server 12 retained by the software manufacturer is checked at a step S5 and, if the confirmation response has been returned, the procedure advances to a step S6. A confirmation request of provision of the bundled software including the serial number and the model number is transmitted to the server 14 retained by the apparatus manufacturer at the step S6. Whether or not the provision confirmation response from the server 14 retained by the apparatus manufacturer in response to this provision confirmation request is present is checked at a step S7 and, if the provision confirmation response is present, the procedure advances to a step S8 at which the utilization flag of the expansion function is turned on. Next, as shown in, for example, the expansion menu 60-2 of the utilization screen 56 of FIG. 3B, whether or not a selected event in the expansion function menu by operation of the menu selection operating units 62 or 64 is present is checked at a step S9 and, if a selected event is present, the procedure advances to a step S10 at which the selected expansion function is executed. As the expansion function executed at the step S10, in this embodiment, the security deployment and the security storage of files are taken as examples. Surely, the expansion functions of the bundled software made available by the present invention can be determined appropriately depending on the type of the bundled software. However, the expansion functions are required to be the expansion functions provided by the apparatus manufacturer to the bundled software provided by the software manufacturer. The expansion functions to the bundled software provided by the apparatus manufacturer are not only software of the function enhancing program, however, the hardware environment of the user information processing apparatus 10 is provided together. For example, in order to make the security file storage available as an expansion function, for example, a security storage area 25-1 secured in the system area that is available only through the expansion menu of an expansion function of the bundled software is prepared in advance in the file storage unit 22 of the user information processing apparatus 10. However, the software manufacturer providing the bundled software can not set this securing of the security storage area 25-1 in the system area and this securing can be said to be a function set by the manufacturer of the user information processing apparatus 10 on the premise of the expansion functions of the bundled software.

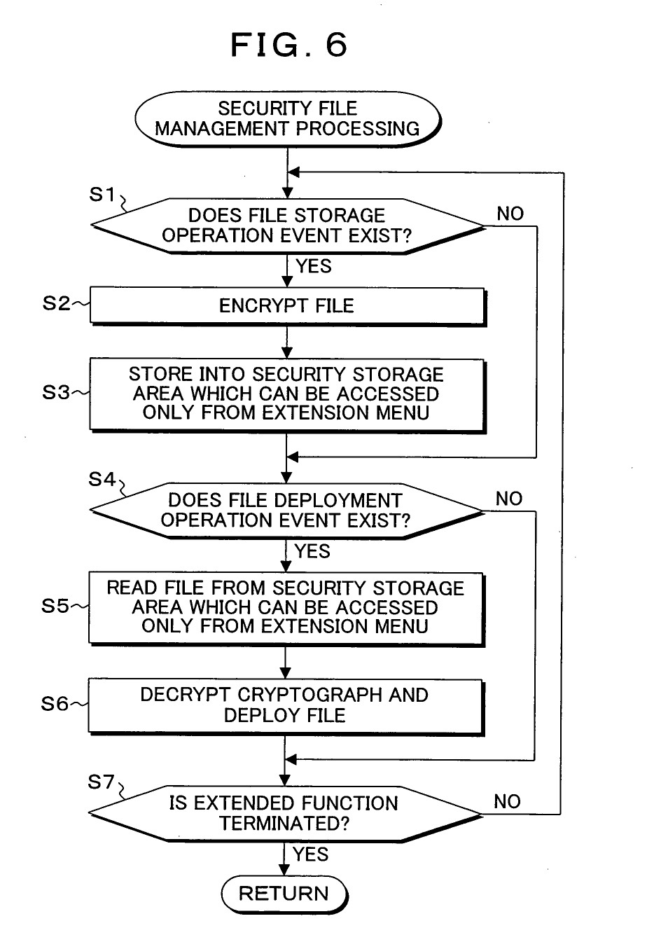

FIG. 6 is a flowchart of a security file management process for storing files in a user apparatus as an example of an expansion function of the bundled software according to the present invention. In FIG. 6, in the security file management process, whether or not a file storage operation event by the expansion menu 60-2 of FIG. 3B is present is checked at a step S1 and, if the operation event is present, the procedure advances to a step S2. Then, after encrypting a created file, the encrypted file is stored in the security storage area 25-1 that can be accessed only from the expansion menu, at a step S3. Then, the file deployment operation event is identified from the expansion menu 60-2 of FIG. 3B at a step S4 and the procedure advances to a step S5 at which the file is read out from the security storage area 25-1 that can be accessed only from the expansion menu. Then, the file is deployed and displayed on a screen by decrypting the cipher in the read-out file at a step S6. The processing steps S1 to S6 are executed in response to the operation event until the expansion function is ended at a step S7.

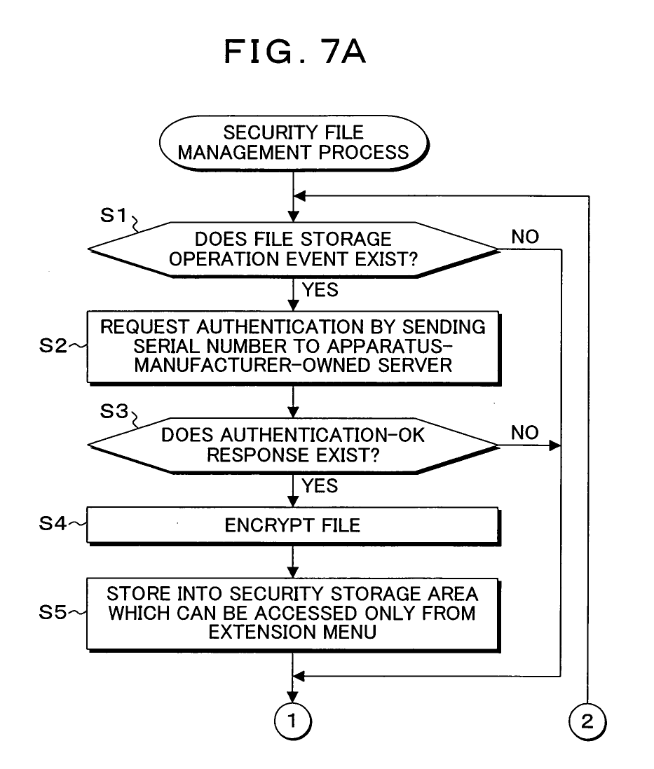

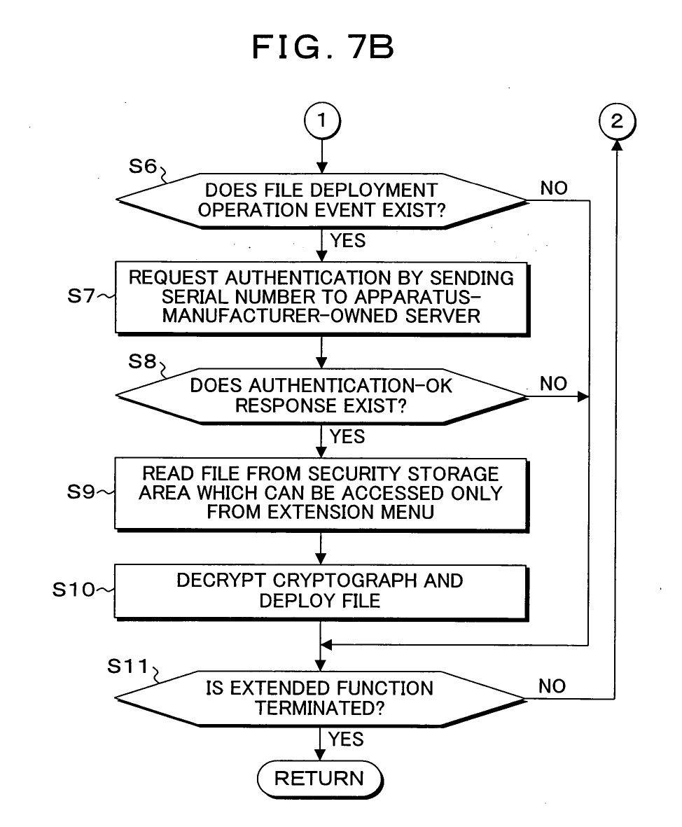

FIGS. 7A and 7B are flowcharts of a security file management process for storing files in the user apparatus based on an authentication process as an example of an expansion function according to the present invention. In FIGS. 7A and 7B, when a file storage operation event is identified at a step S1, an authentication request is conducted by transmitting the serial number 70 of the user information processing apparatus 10 to the server 14 retained by the apparatus manufacturer at a step S2. Receiving this authentication request, the server 14 retained by the apparatus manufacturer searches a serial number database (not shown) and, when the corresponding serial number is obtained, returns a response representing that the authentication is completed. Therefore, when the response representing the completed authentication from the server 14 retained by the apparatus manufacturer is identified at a step S3, the authentication is successful and, after the file is encrypted at a step S4, the encrypted file is stored in the security storage area 25-1 that can be accessed only from the expansion menu at a step S5. On the other hand, when a file deployment operation event is identified at a step S6, an authentication request is conducted by transmitting the serial number 70 to the server 14 retained by the apparatus manufacturer at a step S7. When an authentication completion response is received at a step S8, the file is read out from the security storage area 25-1 that can be accessed only from the expansion menu at a step S9 and the encrypted file is decrypted and the file is deployed and displayed at a step S10. These processing steps S1 to S10 are executed for each operation event until the end of the expansion function is identified at a step S11.

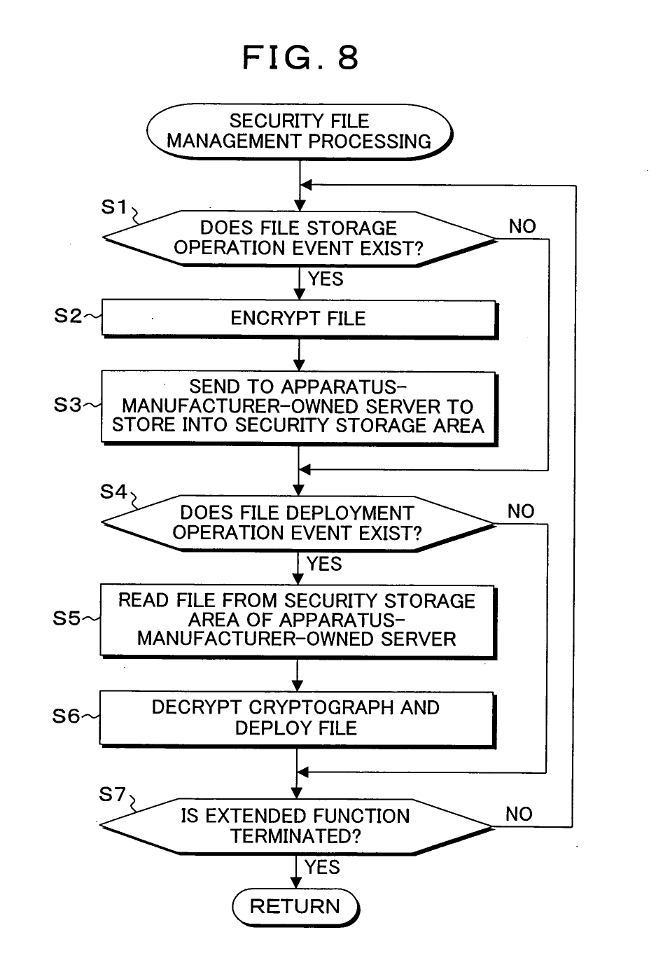

FIG. 8 is a flowchart of a security file management process for storing files in the server 14 retained by the apparatus manufacturer as an example of an expansion function according to the present invention. In FIG. 8, when a file storage operation event is identified at a step S1, the file is encrypted at a step S2. Thereafter, the encrypted file is transmitted to the server 14 retained by the apparatus manufacturer of FIG. 2 and is stored in the security storage area at a step S3. That is, the server 14 retained by the apparatus manufacturer accepts a file storage request from the user information processing apparatus 10 at the expansion service processing unit 46 and the encrypted file is stored in the security storage unit 48. On the other hand, when the file deployment operation event is identified at a step S4, the procedure advances to a step S5 at which the file is read out from the security storage unit 48 of the server 14 retained by the apparatus manufacturer and is transferred and received. Then, the received encrypted file is decrypted, deployed and displayed at a step S6. Then, when the end of the expansion function is identified at a step S7, the series of processing steps are ended.

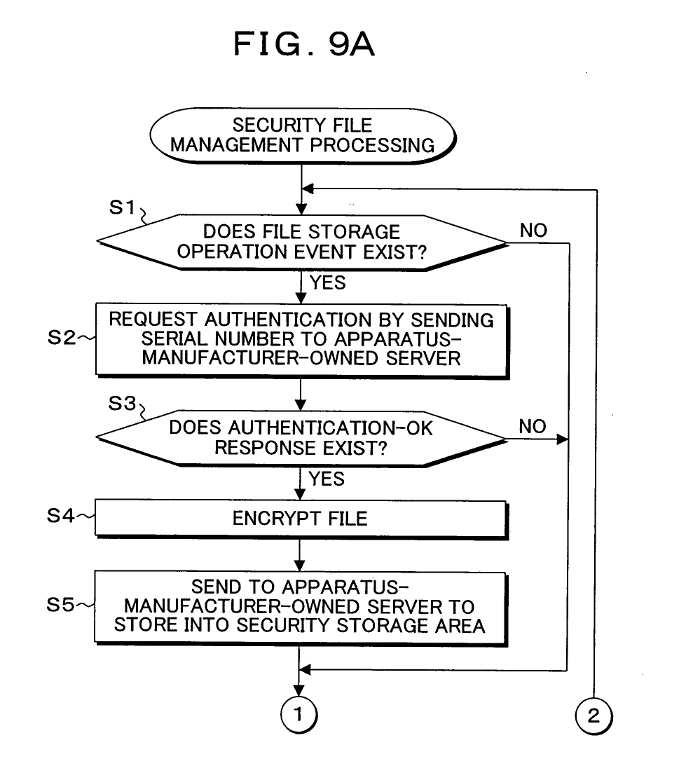

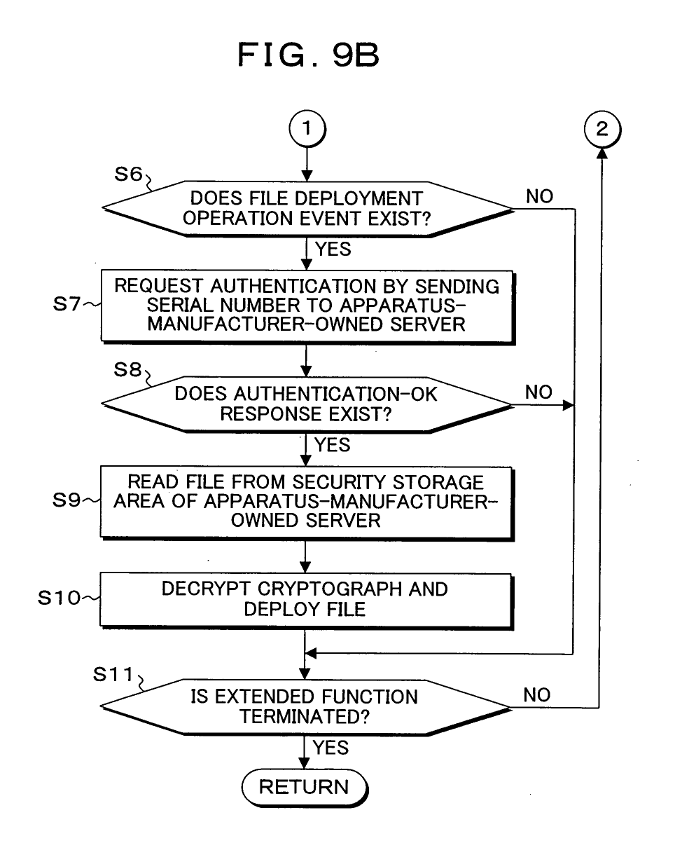

FIGS. 9A and 9B are flowcharts of a security file management process for storing files in a server retained by the apparatus manufacturer based on an authentication process as an example of an expansion function according to the present invention. In FIGS. 9A and 9B, when a file storage operation event is identified at a step S1, the procedure advances to a step S2 at which an authentication request is executed by transmitting the serial number 70 from the user information processing apparatus 10 to the server 14 retained by the apparatus manufacturer. When an authentication completion response is returned from the server 14 retained by the apparatus manufacturer in response to this authentication request at a step S3, the procedure advances to a step S4 at which the file is encrypted. Thereafter, the encrypted file is transmitted to the server 14 retained by the apparatus manufacturer and is stored in the security storage unit 48 that is a security storage area at a step S5. When the file deployment operation event is identified at a step S6, an authentication request is executed by transmitting the serial number 70 to the server 14 retained by the apparatus manufacturer at a step S7 and, when an authentication completion response is obtained at a step S8, the corresponding file is read out from the security storage area that is the security storage unit 48 of the server 14 retained by the apparatus manufacturer, and is transferred and received at a step S9. Then, the encrypted file is decrypted and the file is deployed and displayed at a step S10. These processing steps are repeated for each operation event until the end of the expansion function is identified at a step S11. Using these security file management processes shown in FIG. 6 to FIGS. 9A and 9B obtained by the function enhancement of the bundled software, a user can protect securely the important data from unnecessary deleting and thefts.

Though the above embodiment takes an example of an integrated fixed type unit like a hard disk drive as the file storage unit 22 of the user information processing unit 10, a detachable cartridge medium like a magneto-optical disk drive (MO drive) may be employed as the security storage unit and, in this case, an interface may be constructed such that expansion functions that utilize the hardware and the software of an MO drive provided with a security function is provided using the expansion menu of the bundled software. Furthermore, the present invention provides a function enhancing program utilizing the expansion functions of the bundled software and this function enhancing program has a program structure complying with the procedure of the flowchart of the function expansion process shown in FIGS. 5A and 5B. Moreover, though the above embodiment takes an example of a expansion function of the security file management process of the bundled software, the expansion function of the bundled software can be supplied by the apparatus manufacturer when the apparatus manufacturer provides appropriate expansion functions as hardware and software when necessary. Yet furthermore, though the above embodiment takes an example of a personal computer as the user information processing apparatus 10, the present invention is not limited to this embodiment and can be applied as it is to an appropriate apparatus such as an appropriate information processing apparatus, for example, a PDA, a mobile telephone, a car navigation apparatus, etc. with which apparatus manufacturers bundle software when the apparatus is sold. Yet moreover, in the above embodiment, for utilizing the expansion function of the bundled software in the user information processing apparatus 10, the formal purchase request to the server 12 retained by the software manufacturer and the provision confirmation request to the server 14 retained by the apparatus manufacturer are executed separately. However, a control form may be taken that, consolidating the side of the servers into a single apparatus, the formal purchase request of the bundled software and the provision confirmation request of the bundled software are inquired to one (1) server and, when two (2) confirmation responses can be obtained, the server side directly turns on the flag indicating availability. In addition, the present invention encompasses any appropriate modifications without impairing the object and advantages thereof and is not limited by the numerical values shown in the above embodiment.

What is claimed is:

1. A recording medium which stores a program operable to drive a computer to execute:
a bundled software purchase processing step of transmitting a formal purchase request of the bundled software to a server of a software manufacturer and receiving a confirmation response to the formal purchase;
a bundled software provision confirmation step of transmitting a provision confirmation request of the bundled software to a server of an apparatus manufacturer and receiving a provision confirmation response; and
an expansion function utilization processing step of making the expansion function of the bundled software available when receiving both of the confirmation response to the formal purchase from the server of the software manufacturer and the provision confirmation response from the server of the apparatus manufacturer.

2. A medium according to claim 1, wherein the bundled software provision confirmation step includes transmitting an apparatus model number to the server of the apparatus manufacturer as the provision confirmation request of the bundled software and receiving the provision confirmation response.

3. A medium according to claim 1, wherein the expansion function utilization processing step includes confirming utilization data and making the expansion function available when receiving both of the confirmation response to the formal purchase from the server of the software manufacturer and the provision confirmation response from the server of the apparatus manufacturer.

4. A medium according to claim 1, wherein the expansion function utilization processing step includes making an expansion function installed in advance available when receiving both of the confirmation response to the formal purchase from the server of the software manufacturer and the provision confirmation response from the server of the apparatus manufacturer.

5. A medium according to claim 1, wherein the expansion function utilization processing step includes making available an expansion function downloaded with the confirmation response to the formal purchase from the server of the software manufacturer when receiving both of the confirmation response to the formal purchase from the server of the software manufacturer and the provision confirmation response from the server of the apparatus manufacturer.

6. A medium according to claim 1, wherein the expansion function utilization processing step includes executing a file storage processing provided with a security function.

7. A medium according to claim 6, wherein the expansion function utilization processing step includes encrypting and storing a file provided by the bundled software in a storage area of the apparatus that is accessible from the expansion menu.

8. A medium according to claim 6, wherein the expansion function utilization processing step includes encrypting and storing a file provided by the bundled software in a storage area of the apparatus that is accessible from the expansion menu provided that a permission response is obtained to an authentication request to the server of the apparatus manufacturer using a serial number specific to the apparatus.

9. A medium according to claim 6, wherein the expansion function utilization processing step includes encrypting and storing a file provided by the bundled software in a storage area of the server of the apparatus manufacturer that is accessible from the expansion menu.

10. A medium according to claim 6, wherein the expansion function utilization processing step includes encrypting and storing a file provided by the bundled software in a storage area of the server of the apparatus manufacturer that is accessible from the expansion menu provided that a permission response is obtained to an authentication request to the server of the apparatus manufacturer using a serial number specific to the apparatus.

11. A bundled software function enhancing method for expanding the function of bundled software bundled into an apparatus, the method comprising:
a bundled software purchase processing step of transmitting a formal purchase request of the bundled software to a server of a software manufacturer and receiving a confirmation response to the formal purchase;
a bundled software provision confirmation step of transmitting a provision confirmation request of the bundled software to a sever of an apparatus manufacturer and receiving a provision confirmation response; and
an expansion function utilization processing step of making the expansion function of the bundled software available when receiving both of the confirmation response to the formal purchase from the server of the software manufacturer and the provision confirmation response from the server of the apparatus manufacturer.

12. A method according to claim 11, wherein the bundled software provision confirmation step includes transmitting an apparatus model number to the server of the apparatus manufacturer as the provision confirmation request of the bundled software and receiving the provision confirmation response.

13. A method according to claim 11, wherein the expansion function utilization processing step includes confirming utilization data and making the expansion function available when receiving both of the confirmation response to the formal purchase from the server of the software manufacturer and the provision confirmation response from the server of the apparatus manufacturer.

14. A method according to claim 11, wherein the expansion function utilization processing step includes executing a file storage processing provided with a security function.

15. An information processing apparatus for executing bundled software bundled therein, comprising:
a bundled software purchase processing unit transmitting a formal purchase request of the bundled software to a server of a software manufacturer to receive a confirmation response to the formal purchase;
a bundled software provision confirmation unit transmitting a provision confirmation request of the bundled software to a sever of an apparatus manufacturer to receive a provision confirmation response; and
an expansion function utilization processing unit making the expansion function of the bundled software available when receiving both of the confirmation response to the formal purchase from the server of the software manufacturer and the provision confirmation response from the server of the apparatus manufacturer.

16. An information processing apparatus according to claim 15, wherein the bundled software provision confirmation unit transmits an apparatus model number to the server of the apparatus manufacturer as the provision confirmation request of the bundled software to receive the provision confirmation response.

17. An information processing apparatus according to claim 15, wherein the expansion function utilization processing unit confirms utilization data and makes the expansion function available when both of the confirmation response to the formal purchase from the server of the software manufacturer and the provision confirmation response from the server of the apparatus manufacturer are received.

18. An information processing apparatus according to claim 15, wherein the expansion function utilization processing unit executes a file storage processing provided with a security function.

19. A management apparatus comprising:
a communication control unit communicating with at least one computer;
a bundled data storage unit storing in a correlated manner an apparatus model number of the at least one computer, an identifier of the bundled software loaded in the at least one computer and an expansion function provided by the management apparatus; and
an expansion service processing unit executing the expansion function of the bundled software based on the identifier of the at least one computer.

20. A management apparatus according to claim 19, wherein the expansion service processing unit executes a file storage processing provided with a security function.
